(19) United States
(12) Patent Application Publication
(10) Pub. No.: US 2020/0028408 A1
(43) Pub. Date: Jan. 23, 2020

(54) MAGNETIC ENERGY CONVERSION SYSTEM

(71) Applicant: Brian ARNOLD, Lakeland, FL (US)

(72) Inventor: Brian ARNOLD, Lakeland, FL (US)

(21) Appl. No.: 16/338,371

(22) PCT Filed: Oct. 2, 2017
(86) PCT No.: PCT/US2017/054802

§ 371 Date: Mar. 29, 2019

Related U.S. Application Data
(60) Provisional application No. 62/557,959, filed on Sep. 13, 2017.
(60) Provisional application No. 62/449,594, filed on Jan. 24, 2017.
(60) Provisional application No. 62/401,900, filed on Sep. 30, 2016.

(51) Int. Cl. H02K 7/00; H02K 9/06

(52) U.S. Cl. CPC H02K 7/006; B60L 7/10; H02K 9/06

(57) ABSTRACT

Some implementations include a magnetic energy conversion system comprising a magnet rotor assembly having one or more magnets radially spaced apart, wherein the magnet rotor assembly is configured to be attached to a driveshaft of a vehicle, and a stator assembly having one or more electrical coils, wherein the stator assembly includes a housing and one or more electrical coils, wherein the housing is configured to be placed around the driveshaft of the vehicle and around the magnet rotor assembly attached to the driveshaft so that the one or more electrical coils are in the field of the one or more magnets at least temporarily when the magnet rotor assembly rotates when the driveshaft of the vehicle turns.

### RELATED APPLICATIONS

This application is a national stage application of International Application No. PCT/US17/54802, entitled “Magnetic Energy Conversion System,” which claims the benefit of U.S. Application No. 62/401,900, entitled “Kinetic Energy Conversion System” and filed on Sep. 30, 2016; U.S. Application No. 62/449,594, entitled “Differential Power System, Kinetic Power System, Refrigerated Trailers, And Subway Car Air Conditioning System” and filed on Jan. 24, 2017; and U.S. Application No. 62/557,959, entitled “Magnetic Energy Conversion System” and filed on Sep. 13, 2017, all of which are incorporated herein by reference in their entirety.

### FIELD

Embodiments relate generally to vehicle power systems, and more particularly, to magnetic energy conversion systems.

### BACKGROUND

Large tractor trailer trucks may have large trailers connected the truck and commonly have electrical equipment in the trailers, such as a liftgate which is hydraulically operated for loading and unloading the truck. Truck trailers of this type also frequently carry a pallet mover for moving heavy loaded pallets into and out of the trailer. These pallet movers may also be electrically powered through batteries which are typically re-charged from a 110 volt AC source.

The trailer hydraulic liftgates are typically driven by hydraulic fluid powered by an electric motor driven hydraulic pump which in turn is powered by liftgate batteries. The liftgate batteries are charged from the main engine of the truck. When a trailer is disconnected from the truck or tractor and left in place without the truck, there is no truck engine to power the alternator for recharging the liftgate batteries. The trailer then generally sits idle until the tractor returns so that the liftgate can be operated and the truck unloaded or loaded. This can provide for a great deal of lost time in the loading and unloading the trailer. Currently, tractors must have their engines running to charge the trailer batteries and/or have an auxiliary combustion engine on the trailer to charge the trailer batteries.

Thus, semi truck trailers may have a need for electrical power to power devices such as liftgates (e.g., rear and/or side liftgates), refrigeration systems, rolling doors, lights, and power inverters. In some conventional trailers, the electrical power for the trailer may be provided from an alternator in the truck (or tractor) engine. Also, in some conventional trailers, a battery on the trailer may store power from the truck alternator for later use.

There can be several limitations with conventional trailer power arrangements. A voltage drop may occur from the alternator in the truck to the battery or other electrical device in the trailer. The DC power from the alternator must travel through wiring extending 40-60 feet. The electrical voltage may experience a significant drop (e.g., around 0.9 volts) over this distance.

In some areas, semi trucks may be prohibited from idling the engine for an extended period (e.g., more than 15 minutes) and may include automatic shut off devices if the engine is idled for more than a given period of time without the driver's foot on the brake. Thus, the engine of the truck may need to be turned off while the trucks is being loaded or unloaded. By turning off the truck engine, electrical power must be drawn from a battery. The combination of a voltage drop and need to draw from the battery can deplete the battery quickly and may result in a liftgate, rolling door and/or other trailer electrical equipment being fully or partially inoperable.

Embodiments were conceived in light of the above mentioned needs, problems and/or limitations, among other things.

### SUMMARY

Some implementations include a magnetic energy conversion system comprising: a magnet rotor assembly having one or more magnets radially spaced apart, wherein the magnet rotor assembly is configured to be attached to a driveshaft of a vehicle, and a stator assembly having one or more electrical coils, wherein the stator assembly includes a housing and one or more electrical coils, wherein the housing is configured to be placed around the driveshaft of the vehicle and around the magnet rotor assembly attached to the driveshaft so that the one or more electrical coils are in the field of the one or more magnets at least temporarily when the magnet rotor assembly rotates when the driveshaft of the vehicle turns.

The system can further comprise a fan blade assembly configured to be attached to the driveshaft, wherein the housing includes one or more openings on a first end to provide an air flow into the housing when the fan blade assembly rotates, and wherein the housing includes one or more openings on a second end of the housing opposite the first end of the housing to permit air to leave the housing.

### BRIEF DESCRIPTION OF THE DRAWINGS

FIGS. 1 and 2 show diagrams of refrigeration systems having a magnetic energy conversion unit (FIG. 1) and battery power without a magnetic energy conversion unit (FIG. 2) in accordance with some implementations.

FIGS. 3 and 4 show a wheel interface configured for a wheel having a disc brake assembly in accordance with some implementations.

FIG. 5 shows a diagram of a magnetic power generation system having a portion integrated with a brake drum, a disc brake shroud, or an axle.

FIG. 6 shows an example trailer diagram in accordance with some implementations.

FIG. 7 shows an example trailer power system schematic in accordance with some implementations.

FIG. 8 is a diagram of an example truck in accordance with some implementations.

FIG. 9 is a diagram of an example truck differential power system and a trailer tether/battery in accordance with some implementations.

FIG. 10 is a diagram of an example trailer system in accordance with some implementations.

FIG. 11 is a diagram of an example trailer having a moveable second refrigeration unit and a moveable partition in accordance with some implementations.

FIGS. 12 and 13 are diagrams of example subway (or train car) air conditioning systems in accordance with some implementations.

FIG. 14 shows an example magnetic power conversion unit mounted on a driveshaft in accordance with some implementations.

FIG. 15 shows a block diagram of an example magnetic power conversion system in accordance with some implementations.

FIGS. 16-18 show an example trailer (or cargo area) washing system configured to wash the inside of a semi-trailer in accordance with some implementations.

FIG. 19 shows an example pre-cooling system for a refrigerated semi-trailer or other refrigerated truck cargo area or other type of refrigerated cargo container in accordance with some implementations.

### DETAILED DESCRIPTION

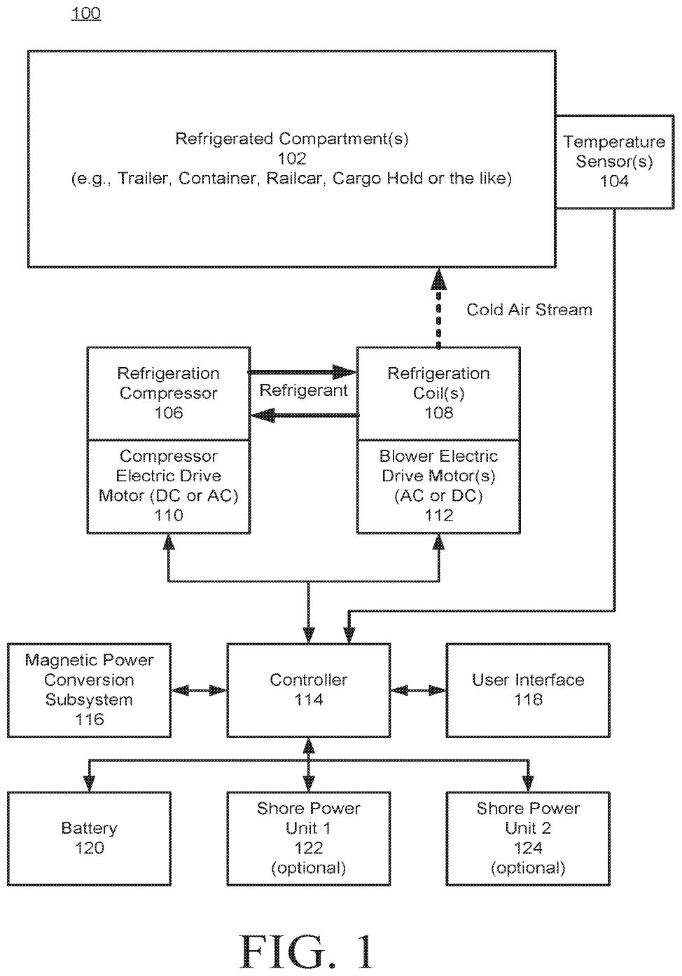

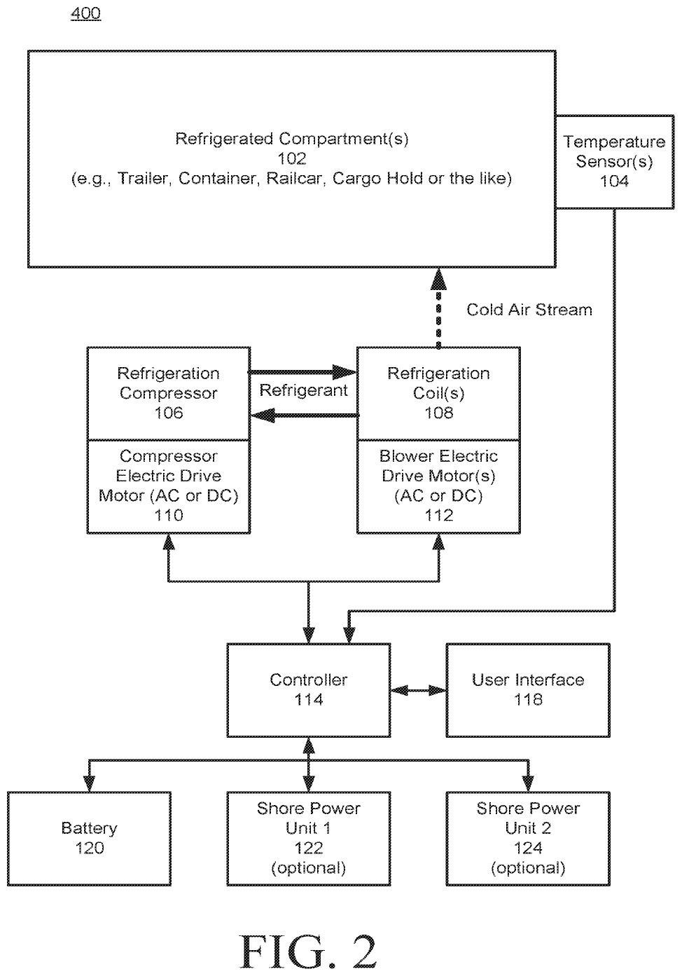

FIG. 1 shows a diagram of an example magnetic energy conversion system (1400) including a refrigeration system. FIG. 2 shows a battery powered refrigeration system with no magnetic energy conversion system. The components shown in FIG. 2 are similar to those mentioned above for FIG. 1, with a difference being that the implementation of FIG. 2 has no magnetic conversion unit and is strictly battery powered.

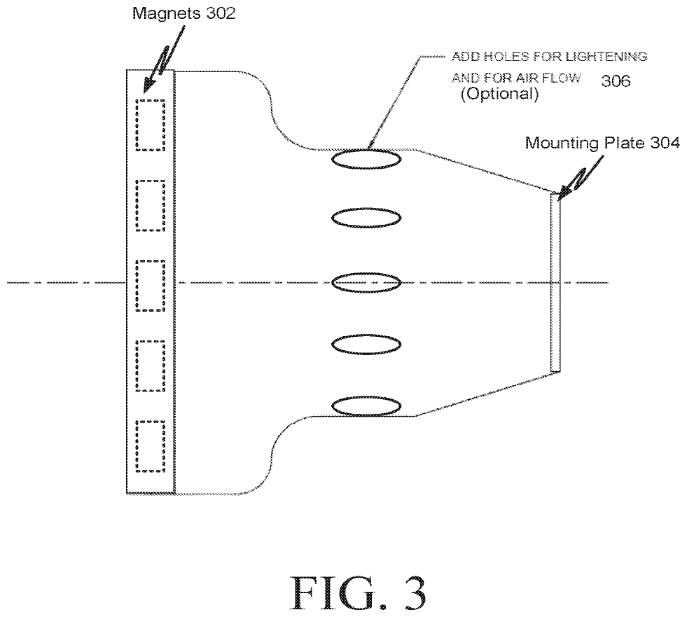

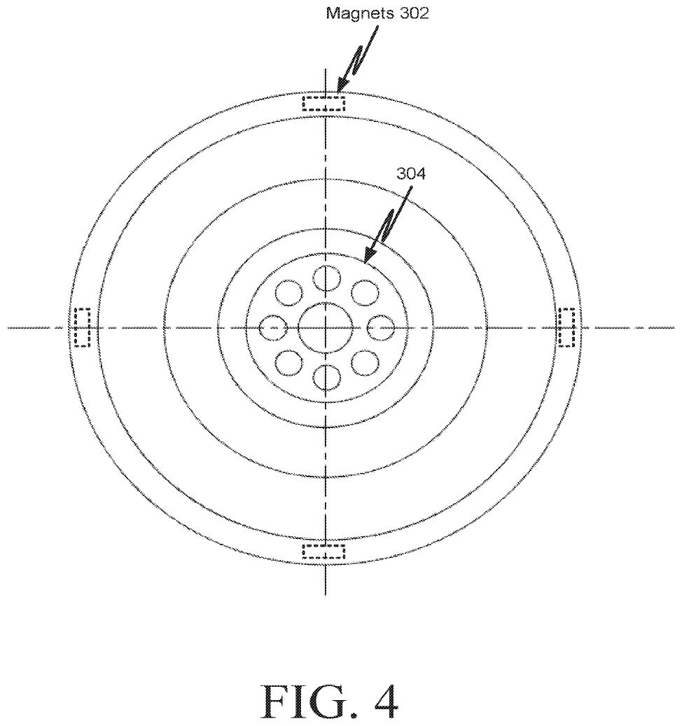

FIGS. 3 and 4 show side and end views, respectively, of an example magnetic conversion system wheel interface 300 for vehicles having disc brakes. The wheel interface 300 is configured to fit over the hub and mount via a mounting plate 304 and to fit around the disc brake calipers of a wheel (e.g., a semi-trailer or other vehicle wheel assembly). The magnets 302 disposed in the outer rim of the wheel interface can magnetically influence a stator assembly, which can convert the magnetic field into electrical energy to provide power to one or more devices in the semi-trailer and/or cab (e.g., refrigeration systems, lift gates, pallet jacks, pallet jack charging systems, or other electrical equipment).

The wheel interface 300 can slip over studs on the wheel end and can be spaced away from the calipers and rotor of the disc brake system so as to avoid interference with the disc brakes. The outer edge of the wheel interface includes magnets 302. The wheel interface can optionally include air holes 306 or scoops to catch and pull air into area where the disc brake caliper is located to help cool the caliper and disc.

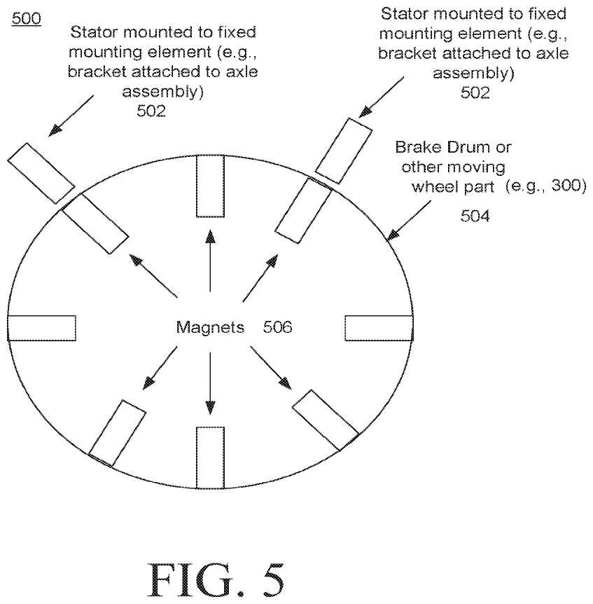

FIG. 5 shows a diagram of a magnetic power conversion system 500 that is configured onto the wheel, axle, or driveshaft assembly of a vehicle (506). For example a semi-trailer brake drum, axle or driveshaft can include built in magnets 502 and a frame surrounding the brake drum, axle or drive shaft that can include one or more stators 502 configured to generate electrical current when the assembly the magnets are attached to rotates. Such a configuration could eliminate the mechanical interface. Further, an alternator could be provided at more than one wheel, axle, or driveshaft with each alternator having the same or different voltage, power output, and current type (e.g., AC or DC). The number and placement of magnets and stators would depend on requirements or specifications for a contemplated embodiment.

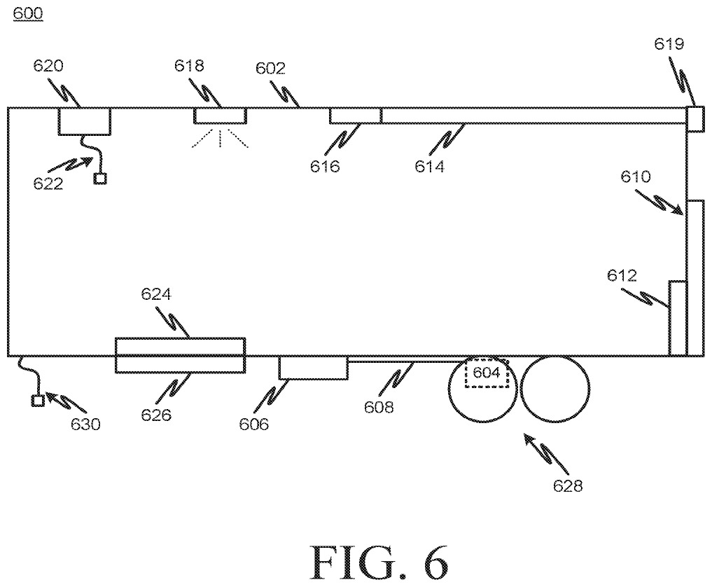

FIG. 6 is a diagram of an example trailer system 600 in accordance with at least one embodiment. The trailer system 600 includes a trailer body 602, a magnetic power conversion unit 604 (e.g., as described above), a battery 606, an electrical harness 608, a rear liftgate 610, a rear liftgate drive system 612, a rolling door mechanism 614, a rolling door drive system 616, one or more interior lights 618, one or more exterior lights 619, an electrical power inverter 620, an inverter electrical cord 622, a side liftgate drive system 624 and a side liftgate 626.

The magnetic power conversion unit 604 can be magnetically coupled (e.g., via a system of magnets and one or more stators) to one or more wheels 628 of the trailer. Rotational motion from the one or more trailer wheels 628 causes the magnets to rotate past electrical coils in the stator of the magnetic power conversion unit. The magnets and stator can form a self-regulated alternator. The magnetic conversion device converts the rotational motion from the wheels 628 to electrical energy. The electrical energy is transmitted via the wiring harness 608 to the battery 606 where the electrical energy can be stored.

In some implementations, the stored electrical energy from the batteries can be provided to the rear liftgate drive system 612 to power the rear liftgate 610. In some implementations, the stored electrical energy can be provided to one or more of the rolling door drive system 616, the one or more interior lights 618, the one or more exterior lights 619, the electrical power inverter 620, and/or the side liftgate drive system 624.

The electrical power inverter 620 can be configured to invert (or convert) electrical power from one format (e.g., 12V DC) to another format (e.g., 120V AC). The inverter electrical cord 622 can include a winding apparatus to manually or automatically retract and wind the cord 622. Also, the cord can include an electrical outlet on the distal end (e.g., a standard 120V AC electrical outlet) to permit a pallet mover to be plugged into the outlet and recharged within the trailer. The system 600 also includes a cab tether 1430 configured to supply power (e.g., 12V DC and/or 110V AC) to the tractor cab for powering cab accessories (e.g., TV, computer, microwave, air conditioner, etc.) while the tractor engine is off. The cab tether 630 can permit the cab to use power from the magnetic power system battery 606 instead of the tractor battery or an auxiliary power unit powered by a combustion engine.

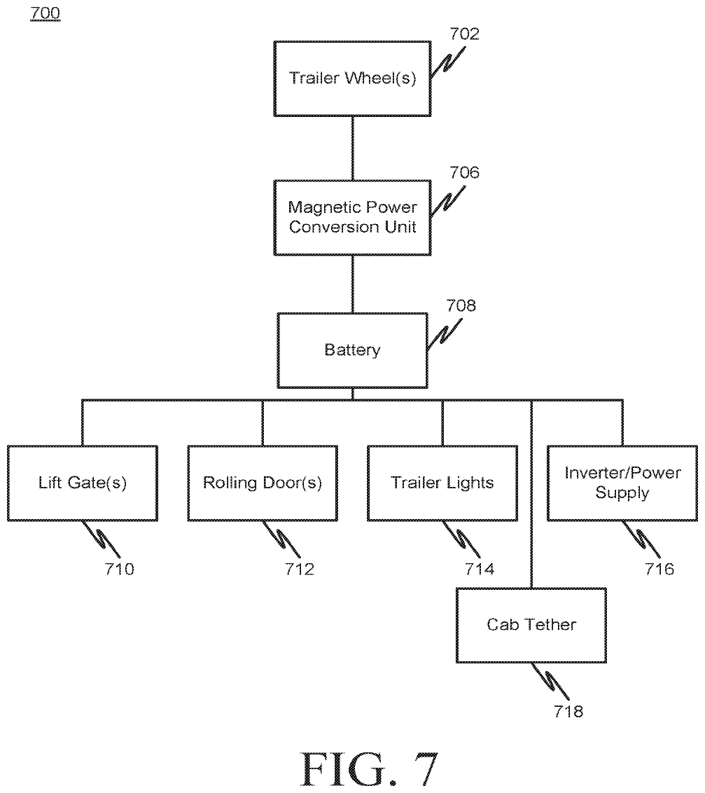

While FIGS. 6 and 7 are diagrams not to scale, it will be appreciated that the battery 606 can be located considerably closer to the magnetic power conversion unit 604 than to an alternator in a truck (e.g., when the magnetic conversion unit is mounted on a rear wheel or rear axle of the a semi-trailer).

FIG. 7 is a schematic of an example trailer power system 700 in accordance with at least one embodiment. The trailer power system 700 includes one or more trailer wheels 1502, a magnetic power conversion unit 706, a battery 708, a liftgate 710, a rolling door 712, one or more trailer lights 714 (interior and/or exterior), an inverter 716 and a cab power tether 718.

The one or more trailer wheels 702 (or axles, or drive shafts) are magnetically coupled (e.g., via magnets and stators) to a magnetic power conversion unit 706 that includes a device to convert moving magnetic field energy into electrical energy (e.g., a self-regulated alternator formed by the magnets and stators).

The electrical energy may be stored in the battery 708 and provided to one or more of the liftgate(s) 710, the rolling door(s) 712, the trailer lights 714, the inverter 716 and/or the cab tether 718.

The dual alternators can have various configurations. For example, the dual alternators can include two DC alternators (or generators), one AC alternator and one DC alternator, or two AC alternators. For example, in an all DC version, a first alternator can include a 12V DC alternator (e.g., for lift gates) and a 24V DC alternator (e.g., for a pallet jack).

The dual alternator configuration can eliminate a need for inverters or convertors, which may have certain environmental limitations (e.g., may be subject to damage from water, heat, vibration, etc.) and are a source of power consumption. Thus, the dual alternators can solve the technical problem of needing to generate and provide two different voltages and/or current types in a relatively harsh environment (the under carriage of a semi-trailer, for example).

In another example, a first alternator can include a DC alternator (e.g., 12V Dc or 24 V DC for a lift gate) and a second alternator can include a 110V AC alternator for powering a pallet jack and/or pallet jack charging station.

Further, there can exist a technical problem in that the voltage drop along a wiring harness that carries electrical current from the cab of a semi tractor to the rear area of a semi-trailer (which may be 40 feet or longer) can significantly reduce the voltage so as to not provide sufficient voltage to properly charge batteries disposed in the trailer (e.g., for lift gate operation or pallet jack operation). By providing regulated power from a dedicated alternator closer (e.g., 15 feet-18 feet) to the devices that are using the power (e.g., one of the alternators shown in FIGS. 3-10), there is less voltage drop and sufficient power can be provided to keep device batteries charged (e.g., lift gate batteries and pallet jack batteries).

Some implementations can include a three alternator configuration. The three alternator configuration can include two alternators operated from one drive belt (e.g., 12 V or 24 V DC alternators for lift gates, pallet jacks, etc.) and a third alternator driven by a dedicated second drive belt, where the third alternator may be a 48V DC alternator to power a refrigeration unit, for example.

Magnetic conversion systems as discussed herein can also include an interface to other systems. For example, the magnetic conversion system has data available related to the movement of semi-trailer wheels or driveshaft, for example. This data can be provided to a driver logging system as an added input for electronic logging that can serve as a verification of the logging data entered by a driver or received from other sensors or systems. Further, the magnetic power conversion system can provide other data (e.g., temperatures if a refrigeration system is present, lift gate operation cycles to help verify delivery stops and usage of lift gate, etc.).

Also, a position determination system (e.g., global position system or GPS receiver) could be added to a magnetic energy conversion system to provide location information of the trailer (or other vehicle or device that the magnetic energy conversion system is installed into).

Some implementations can include a carbon dioxide scrubber disposed on a radiator of a semi-trailer refrigeration unit.

Some implementations can include a refrigeration system having a DC scroll compressor powered by the magnetic energy conversion system described herein.

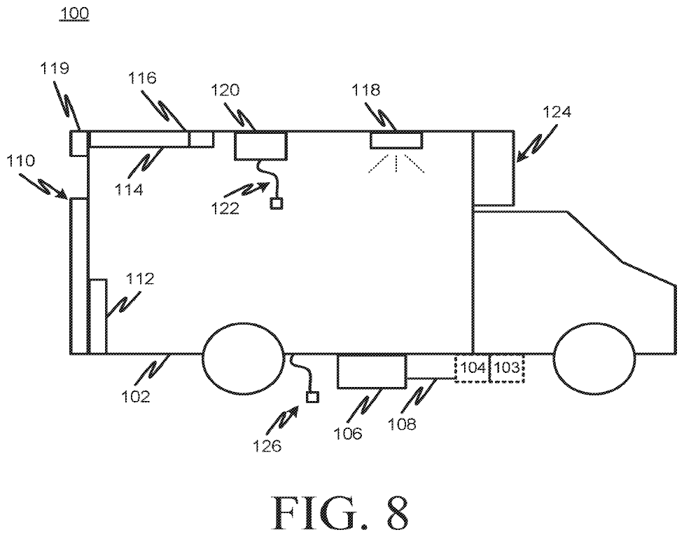

FIG. 8 is a diagram of an example truck 800 in accordance with at least one embodiment. The truck 800 includes a truck cargo area 802, a driveshaft 803, a magnetic power conversion unit 804, a battery 806, an electrical harness 808, a rear liftgate 810, a rear liftgate drive system 812, a rolling door mechanism 814, a rolling door drive system 816, one or more interior lights 818, one or more exterior lights 819, an electrical power inverter 820, an inverter electrical cord 822, a side liftgate drive system 824 and a side liftgate 826.

The magnetic power conversion unit 804 (e.g., 1400) can be magnetically coupled and configured to convert motion of the drive shaft 103 of the truck 800 to electrical energy. The magnetic power conversion unit 804 converts rotational motion of the drive shaft 803 to electrical energy. The electrical energy is transmitted via the wiring harness 808 to the battery 806 where the electrical energy can be stored.

In some implementations, the stored electrical energy from the batteries can be provided to the rear liftgate drive system 812 to power the rear liftgate 810. In some implementations, the stored electrical energy can be provided to one or more of the rolling door drive system 816, the one or more interior lights 818, the one or more exterior lights 819, the electrical power inverter 820, the side liftgate drive system 824, and/or a tether 826.

The electrical power inverter 820 can be configured to invert (or convert) electrical power from one format (e.g., 12V DC) to another format (e.g., 120V AC). The inverter electrical cord 822 can include a winding apparatus to manually or automatically retract and wind the cord 822. Also, the cord can include an electrical outlet on the distal end (e.g., a standard 120V AC electrical outlet) to permit a pallet mover to be plugged into the outlet and recharged within the truck cargo area 802. The system 800 also includes a tether 826 configured to supply power (e.g., 12V DC and/or 110V AC) to a trailer (e.g., for recharging batteries in the trailer) and/or to the truck cab for powering accessories in the cab (e.g., TV, computer, microwave, air conditioner, etc.) while the truck engine is off. The tether 826 can permit the cab to use power from the kinetic power system battery 806 instead of the truck battery or an auxiliary power unit powered by a combustion engine.

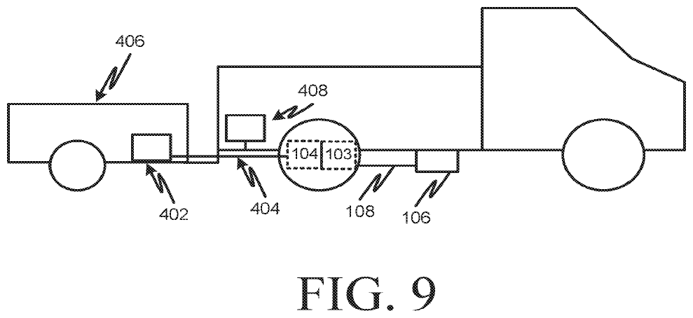

FIG. 9 is a diagram of a truck differential power system and a trailer tether/battery in accordance with at least one embodiment. The magnetic power system 804 in the truck can provide power to charge a battery 902 (or other electrical devices) in a trailer 906 via a trailer tether 904. The trailer tether 904 can include a flexible electrical tether that couples the trailer battery 902 with the magnetic power system 804.

The battery 902 can include one or more rechargeable batteries (e.g., lithium ion batteries) in a trailer for camping, construction, boating, etc. The battery 902 can be removable and portable. Thus, the battery 902 can provide power to electrical devices in the trailer 906 or connected to the trailer 906, and be removable to provide power to locations external to the trailer 906. The truck can include a charging station 908 in the bed of the truck so that removable/portable batteries (e.g., 902) can be placed in the bed of the truck for charging.

In addition to providing electrical power for a cargo area of a truck or a trailer, some implementations can be configured to provide electrical power for equipment in vehicles such as ambulances, police cars, fire trucks, etc. Some implementations of the trailer charging system described above can be configured for trailers such as portable bathrooms, emergency response trailers, disaster recovery trailers, etc.

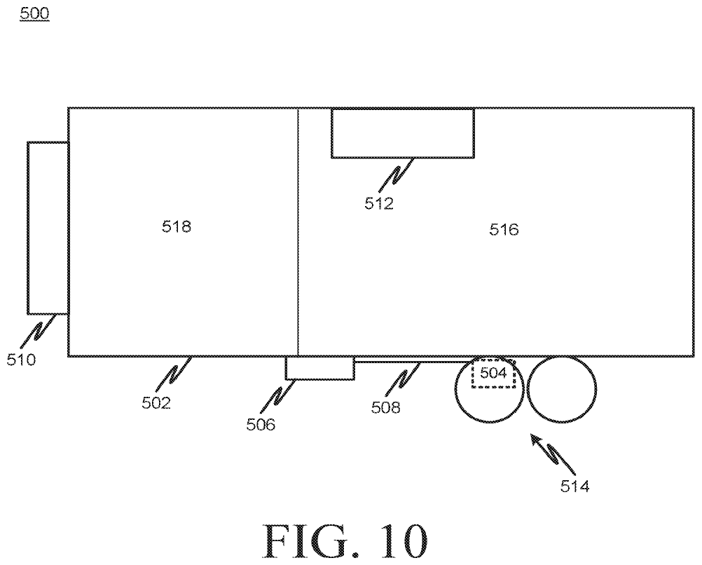

FIG. 10 is a diagram of an example trailer system 1000 in accordance with some implementations. The trailer system 1000 includes a trailer body 1002, a magnetic power conversion unit 1004 (e.g., as described above and below), a battery 1006, an electrical harness 1008, a first refrigeration unit 1010 and a second refrigeration unit 1012.

The kinetic power conversion unit 1004 can be mechanically coupled (e.g., via a transmission) to one or more wheels 1014 of the trailer. The transmission can be configured to transmit rotational kinetic energy from the one or more trailer wheels 1014 to a mechanical-to-electrical conversion device in the kinetic power conversion unit 1004. The mechanical-to-electrical conversion device can include one or more self-regulated alternators. The mechanical-to-electrical conversion device converts the kinetic energy transmitted from the wheels 1014 to electrical energy. The electrical energy is transmitted via the wiring harness 1008 to the battery 1006 where the electrical energy can be stored.

In some implementations, the stored electrical energy from the battery 1006 can be provided to the first refrigeration unit 1010 and/or the second refrigeration unit 1012.

The first refrigeration unit 1010 and/or the second refrigeration unit 1012 can include a direct current (DC) scroll compressor. The second refrigeration unit 1012 can be operated independently of the first refrigeration unit 1010 in order to provide a separate cooling zone 1016 at a same or different temperature (e.g., the second zone could be cooled to a refrigeration temperature, while the first zone is cooled to a freezing temperature, or vice versa) than a first cooling zone 1018. The two cooling zones could both be cooled to refrigeration temperatures (either the same or different temperatures, or both be cooled to freezing temperatures (the same or different freezing temperatures), or one zone could be refrigeration and one zone could be freezing.

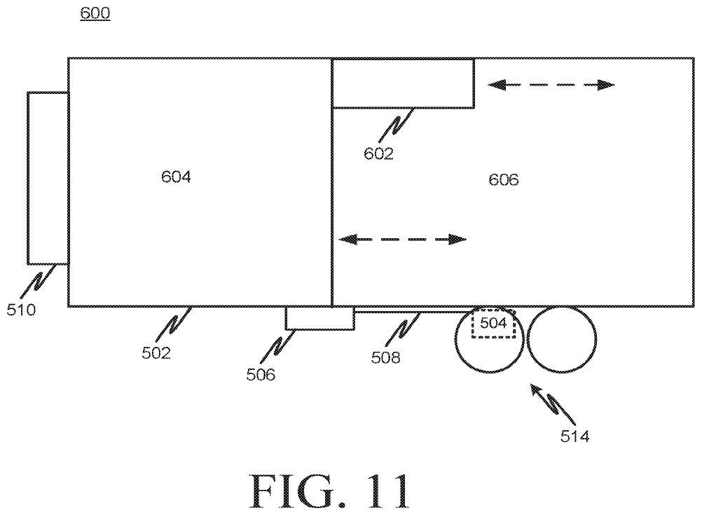

FIG. 11 is a diagram of an example trailer 1100 having a moveable second refrigeration unit 1102 and a moveable partition 1103 to create a first cooling zone 1104 and second cooling zone 1106 of variable (and adjustable) size depending on the location of the second refrigeration unit 1102 and/or the location of the moveable partition 1103.

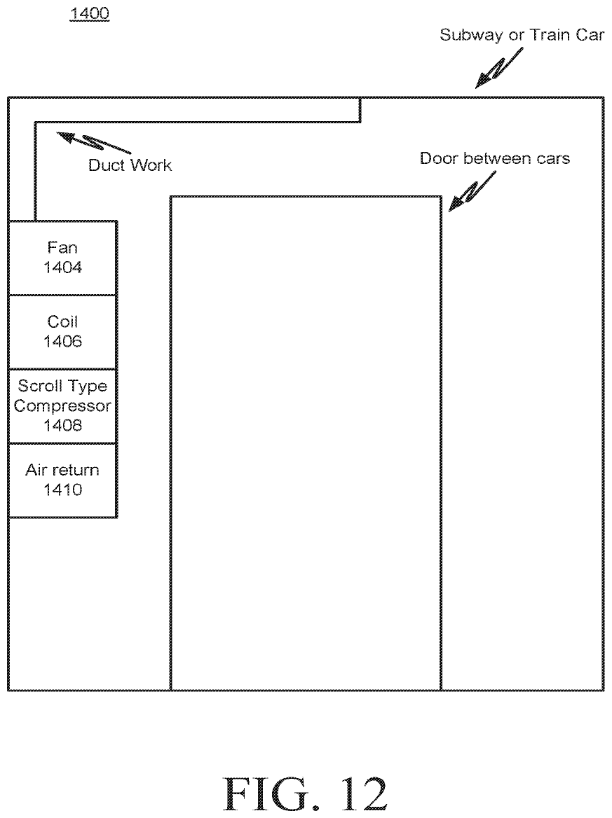

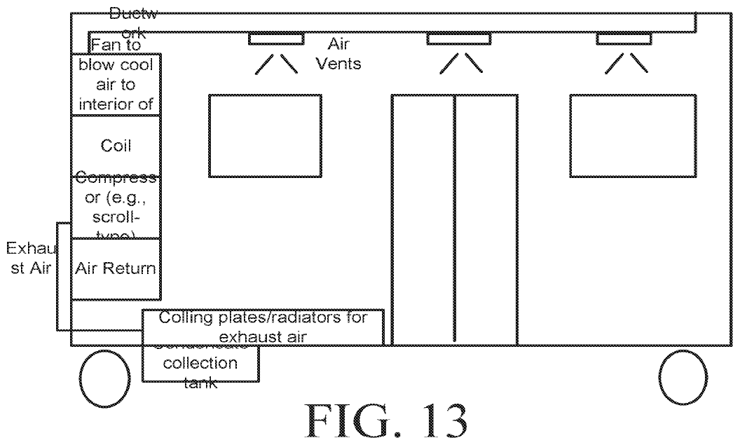

FIGS. 12 and 13 are diagrams of an example subway (or train car) air conditioning system in accordance with some implementations. The compressor 1208 and fans 1204 for the subway air conditioning system are powered from AC or DC electricity provided by the electrical supply for the train (e.g., from the track or from another electrical supply system for the train).

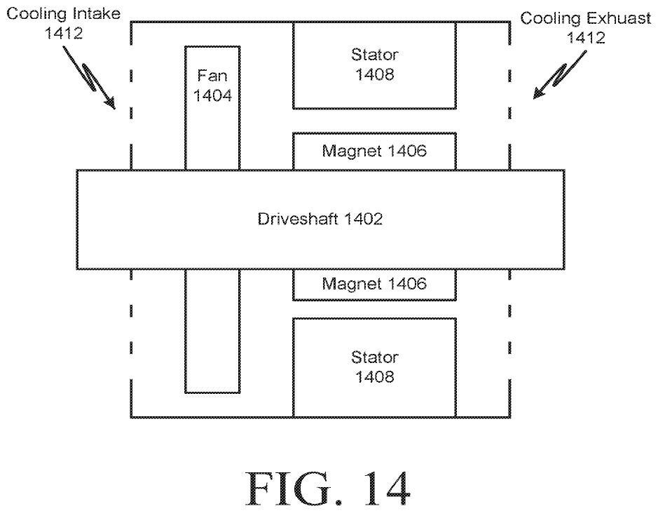

FIG. 14 shows a magnetic power conversion unit 1400 mounted on a driveshaft 1402. The magnetic power conversion unit 1440 can includes a fan blade assembly 1404, a magnet assembly 1406 (having one or more magnets), one or more stators 1408 with electrical coils and ferromagnetic cores. The magnetic power conversion unit includes a housing 1410 (e.g., an insulated housing), cooling air intake vents 1412 and exhaust air outlet vents 1414. The fan blade assembly 1404 and the magnet assembly 1406 are mounted around the drive shaft and rotate when the drive shaft 1402 rotates. For example, the fan blade assembly 1404 and the magnet assembly 1406 can be in two (or more) parts that are placed around the driveshaft and connected to each other and secured to the drive shaft. The housing 1410 and stator(s) 1408 are mounted to a fixed part of the vehicle and configured in such a way as to surround the drive shaft 1402 (and the fan blade assembly 1404 and the magnet assembly 1406).

When the drive shaft 1402 turns, the fan blade assembly 1404 will turn, causing air to flow into the cooling intakes 1412 and out of the exhaust port 1414. Also, the magnet assembly 1406 will rotate along with the drive shaft and a magnetic field of the magnet(s) in magnet assembly 1406 will pass the coils of the stator 1408 and cause an electrical current to flow from the stator 1408 to provide power to one or more of the device discussed about.

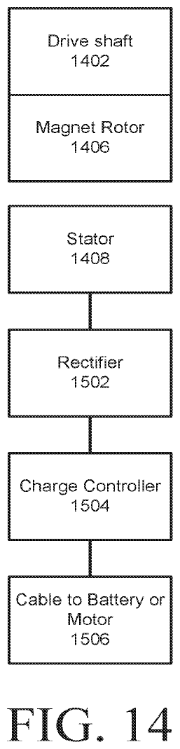

FIG. 15 shows a block diagram of a magnetic power conversion system 1500 having a drive shaft 1402, a magnet assembly 1406, a stator 1408, a rectifier 1502, a charge controller 1504, and a cable (e.g., to a battery or motor) 1506.

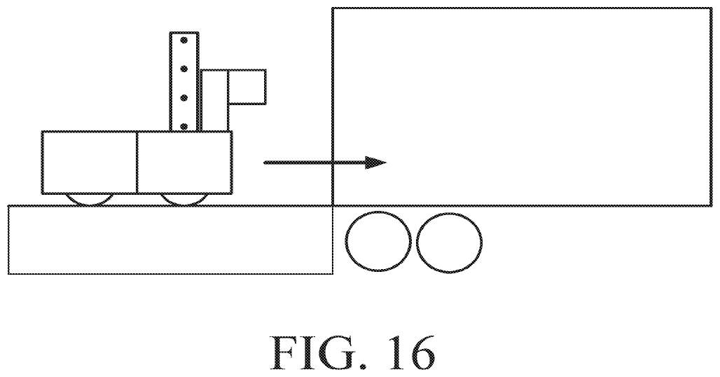

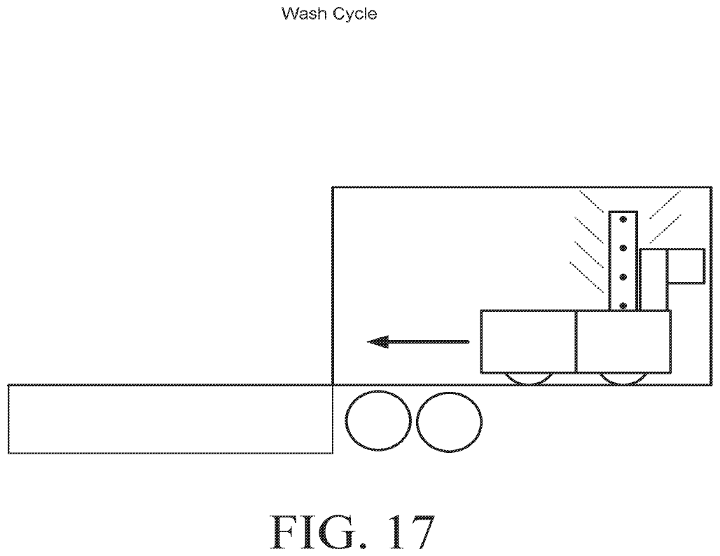

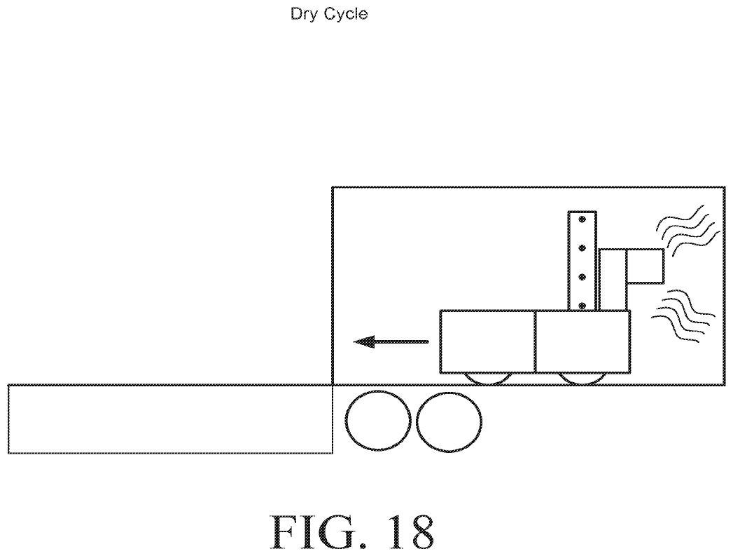

FIGS. 16-18 show a trailer (or cargo area) washing system 1602 configured to wash the inside of a semi-trailer 1604 (or cargo area of another type of truck such as a box truck). The trailer washing system can move inside the trailer and perform a wash cycle (FIG. 17) and a dry cycle (FIG. 18). In the wash cycle, the trailer washing system 1602 sprays the inside of the trailer with a washing solution. In the dry cycle, the truck washing system blows air into the inside of the trailer. The trailer washing system 1602 includes a tank for cleaning solution, cleaning solution spray nozzles, and a hot air blowing system for the drying cycle. The trailer washing system 1602 can record which trailer was washed and the date and time the trailer was washed and provide the washing records to other systems as documentation of compliance with trailer washing laws or rules.

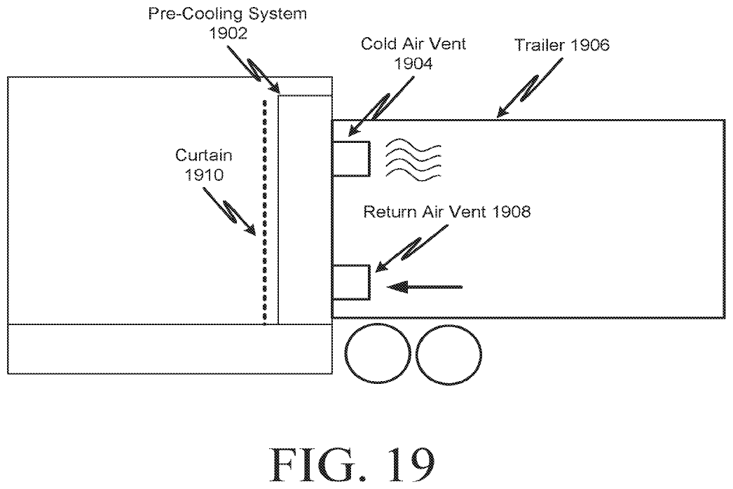

FIG. 19 shows a pre-cooling system 1902 for a refrigerated semi-trailer or other refrigerated truck cargo area or other type of refrigerated cargo container. The precooling system 1902 includes a blast chiller cold air output nozzle 1904 that can be positioned inside a refrigerated semi trailer 1906. The pre-cooling system can also include a return air vent 1908 that can be placed inside the trailer. In operation, when the trailer 1906 needs to be cooled prior to being loaded with refrigerated or frozen cargo, the trailer 1906 can be positioned at the pre-cooling system 1902 (which can be part of a loading dock bay), and the pre-cooling system 1902 can use a high intensity cooler (e.g., a blast chiller) to rapidly bring the temperature inside the trailer down to the desired temperature for refrigerated or frozen cargo.

It is, therefore, apparent that there is provided, in accordance with the various embodiments disclosed herein, magnetic energy conversion systems and methods.

While the disclosed subject matter has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

What is claimed is:

1. A magnetic energy conversion system comprising:
a magnet rotor assembly having one or more magnets radially spaced apart, wherein the magnet rotor assembly is configured to be attached to a driveshaft of a vehicle;
a stator assembly having one or more electrical coils, wherein the stator assembly includes a housing and one or more electrical coils, wherein the housing is configured to be placed around the driveshaft of the vehicle and around the magnet rotor assembly attached to the driveshaft so that the one or more electrical coils are in the field of the one or more magnets at least temporarily when the magnet rotor assembly rotates when the driveshaft of the vehicle turns.

2. The magnetic energy conversion system of claim 1, further comprising a fan blade assembly configured to be attached to the driveshaft, wherein the housing includes one or more openings on a first end to provide an air flow into the housing when the fan blade assembly rotates, and wherein the housing includes one or more openings on a second end of the housing opposite the first end of the housing to permit air to leave the housing.
